(19) United States
(12) Patent Application Publication
(10) Pub. No.: US 2005/0076346 A1
(43) Pub. Date: Apr. 7, 2005

(54) Optical disk apparatus

(75) Inventors: Kazuo Matsumoto, Kikuchi-gun (JP); Futoshi Kuriyama, Kumamoto-shi (JP)

Correspondence Address: STEVENS DAVIS MILLER & MOSHER, LLP, 1615 L STREET, NW, SUITE 850, WASHINGTON, DC, 20036, US

(73) Assignee: MATSUSHITA ELECTRIC INDUSTRIAL CO., LTD., Osaka (JP)

(21) Appl. No.: 10/954,604

(22) Filed: Oct. 1, 2004

(30) Foreign Application Priority Data
Oct. 2, 2003 (JP) 2003-344147
Sep. 14, 2004 (JP) 2004-266400

(51) Int. Cl. G11B 17/03; G11B 17/04; G11B 33/02

(52) U.S. Cl. 720/601

(57) ABSTRACT

An optical disk apparatus includes a cabinet having an opening portion, a tray insertably and drawably held by the cabinet and brought in and out to and from the opening portion, and a motor provided at the tray, holding an optical disk and driven to rotate, in which a distance from an end of the opening portion to a rotational center of the rotational driving portion in a state of maximally drawing out the tray is made to be smaller than a radius of an optical disk having a maximum diameter capable of being mounted to the rotational driving portion. Thereby, the optical disk apparatus can be light-weighted.

### BACKGROUND OF THE INVENTION

1. Field of the Invention

The present invention relates to an optical disk apparatus used by being included or outwardly fitted to an electronic apparatus of a personal computer or the like. Further, the invention relates to a disk apparatus of a magnetic disk apparatus or the like.

2. Description of the Related Art

FIG. 9 is an outlook view of an optical disk apparatus of a tray system of a background art and FIG. 10 is a view removing a ceiling portion in the outlook view of the optical disk apparatus of the tray system of the background art. An optical disk apparatus 1 is provided with a cabinet 2 and a tray 3 and FIG. 9 and FIG. 10 show a state of drawing out the tray 3 from the cabinet 2. The cabinet 2 is constituted by a ceiling portion 2a and a bottom portion 2b. The tray 3 is provided with a pickup module 4. The pickup module 4 is constituted with a spindle motor 4a for rotating an optical pickup 5 constituting an optical system and a disk and a tray side circuit board 4c constituting a control circuit. The spindle motor 4a is provided with a disk mounting portion 4b for mounting the disk to drive to rotate. Both side portions of the tray 3 are provided with rail portions 6 and the both side portions are fitted with rails 7 slidably in a direction of drawing out the disk. Further, the rails 7 are also fitted with rail guides 8 provided at inner faces of both side portions of the cabinet 2 slidably in the direction of drawing out the disk and the tray 3 can be drawn out to be able to attach and detach the disk to and from the cabinet 2. An amount of drawing out the tray 3 is set such that a total of the mounted optical disk is drawn out from the cabinet 2 to expose in a state of being maximally drawn out from the cabinet 2.

The bottom portion 2b of the cabinet 2 is provided with a cabinet side circuit board 9 constituting the control circuit. The cabinet side circuit board 9 is provided with a connector 9a for supplying power from outside and inputting and outputting a signal. The cabinet side circuit board 9 and the tray side circuit board 4c provided at the tray 3 are connected by a flexible print cable 10. The flexible print cable 10 is substantially constituted by a U-like shape and is connected to the tray side circuit board 4c by folding back one arm thereof. A folded back portion 10a is moved in parallel with a direction of bringing in and out the tray 3 by bringing in and out the tray 3.

As background arts, there are (JP-A-7-254199), (JP-A-2003-22599) and the like.

According to the optical disk apparatus of the tray system of the background art, the amount of drawing out the tray 3 is set such that the total of the mounted optical disk is drawn out from the cabinet 2 to expose in a state of being maximally drawn out from the cabinet 2 and therefore, the amount of drawing out the tray 3 is large. Therefore, there are needed two stages of sliding fitting structures of a fitting structure of sliding the rail portions 6 of the both side portions of the tray 3 and the rails 7 and a fitting structure of sliding the rails 7 and the rail guides 8 provided at the inner faces of the both side portions of the cabinet. Therefore, not only the structure is complicated but also a number of parts is increased to cause to increase a weight of the optical disk apparatus.

### SUMMARY OF THE INVENTION

In order to resolve such a problem, according to the invention, a distance from an end of an opening portion to a rotational center of a motor in a state of maximally drawing out a tray is made to be smaller than a radius of an optical disk having a maximum diameter capable of being mounted to the motor.

A weight of an optical disk apparatus can be reduced by the invention.

### BRIEF DESCRIPTION OF THE DRAWINGS

FIG. 1 is an outlook view showing a state of drawing out a tray in an optical disk apparatus according to an embodiment of the invention.

FIG. 2 is an outlook view showing the state of drawing out the tray in the optical disk apparatus according to an embodiment of the invention in which a ceiling plate of a cabinet is removed.

FIG. 3 illustrates side views for explaining attachment of an optical disk to the optical disk apparatus according to the embodiment of the invention and views of a state of maximally drawing out the tray.

FIG. 4 is an outlook view of a state of drawing out a tray in an optical disk apparatus according to other embodiment of the invention. X

FIG. 5 is an outlook view showing the state of drawing out the tray in the optical disk apparatus according to other embodiment of the invention in which a ceiling plate of a cabinet is removed.

FIG. 6 is a side view for explaining attachment of an optical disk in the optical disk apparatus according to other embodiment of the invention.

FIG. 7 is a front view of a tray portion of the optical disk apparatus according to other embodiment of the invention.

FIG. 8 is an outlook view showing the state of containing the tray of the optical disk apparatus according to other embodiment of the invention.

FIG. 9 is an outlook view of an optical disk of a tray system of a background art.

FIG. 10 is an outlook view of the optical disk of the tray system of the background art in which a ceiling portion is removed.

### DESCRIPTION OF THE PREFERRED EMBODIMENTS

A first aspect of the invention is an optical disk apparatus comprising a cabinet having an opening portion, a tray insertably and drawably held to and from the cabinet and brought in and out to and from the opening portion, and a motor provided at the tray, holding an optical disk and driven to rotate, wherein a distance from an end of the opening portion to a rotational center of the motor in a state of maximally drawing out the tray is smaller than a radius of the optical disk having a maximum diameter capable of being mounted to the. rotational driving portion. Even in a state of drawing out the tray from the cabinet, the tray and the cabinet are maintained to be fitted with each other without a rail and therefore, the structure can be simplified, a number of parts can be reduced and a weight of the optical disk apparatus can be reduced.

A best mode for carrying out the invention will be explained in reference to the drawings as follows.

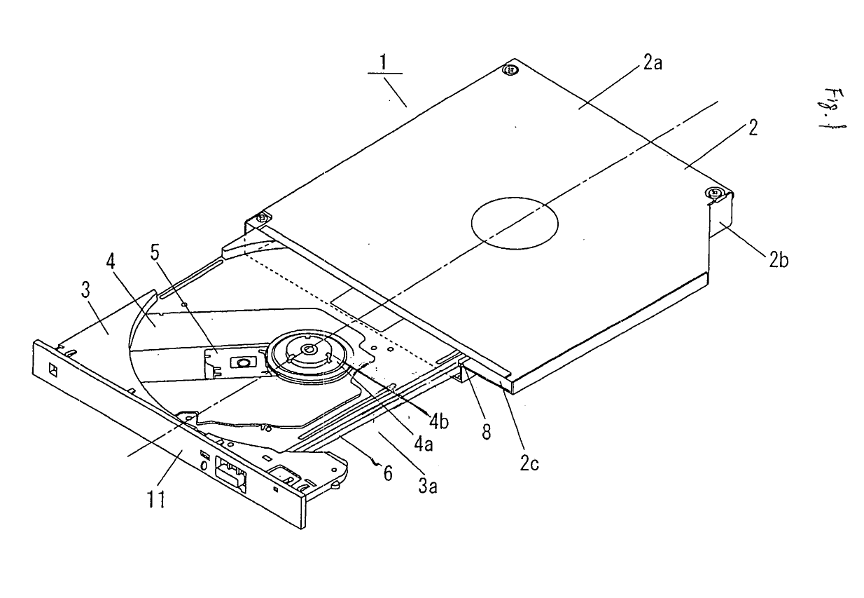

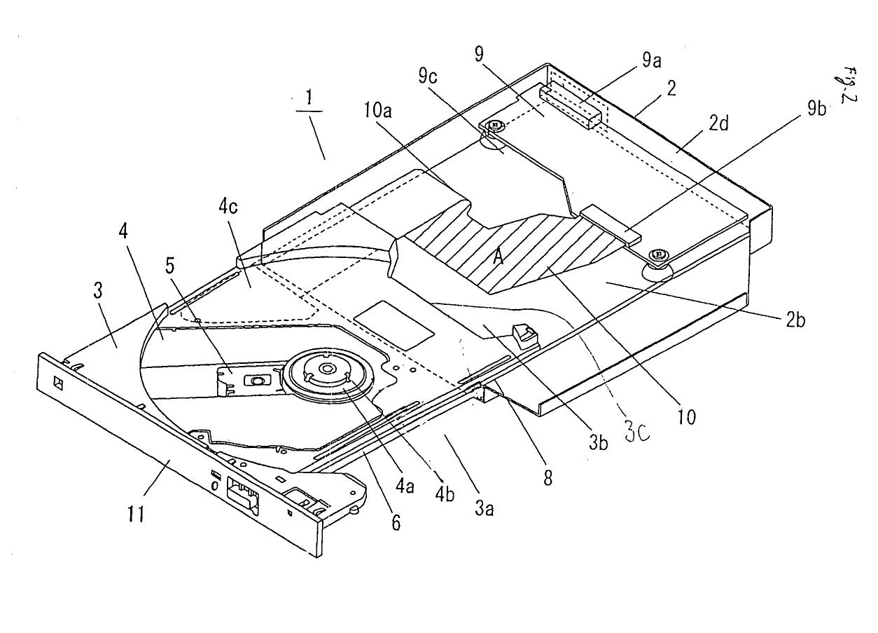

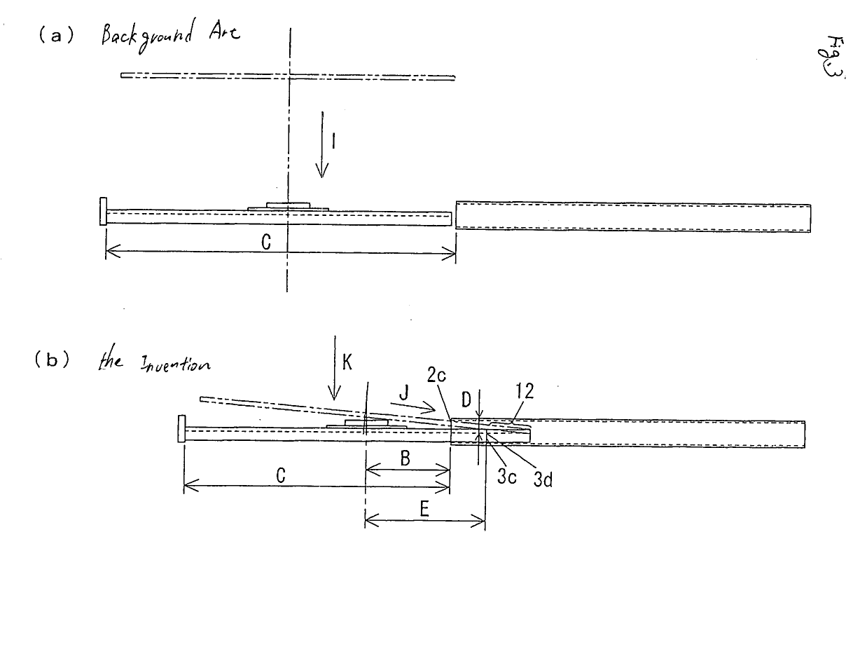

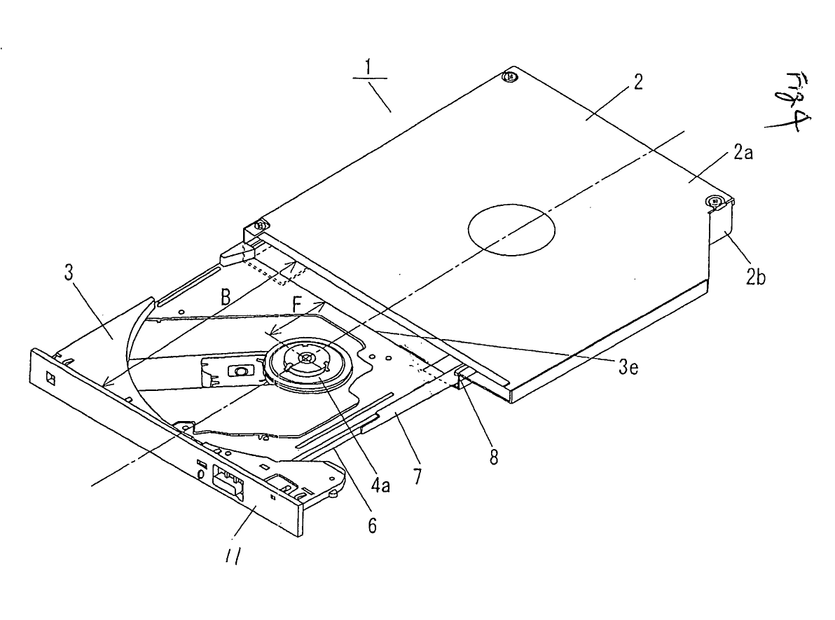

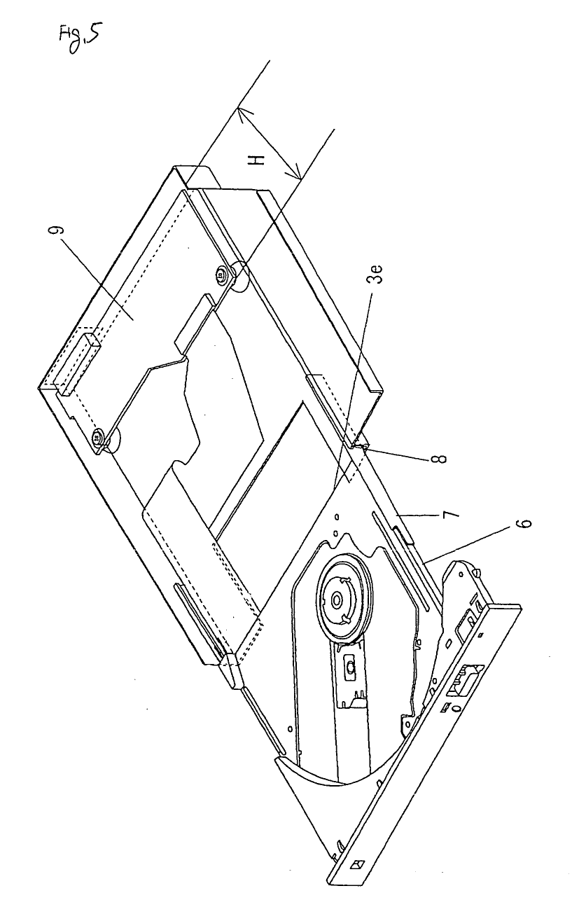

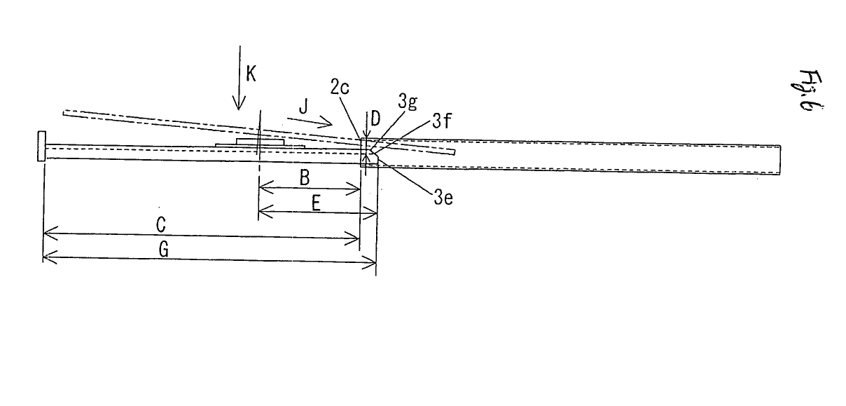

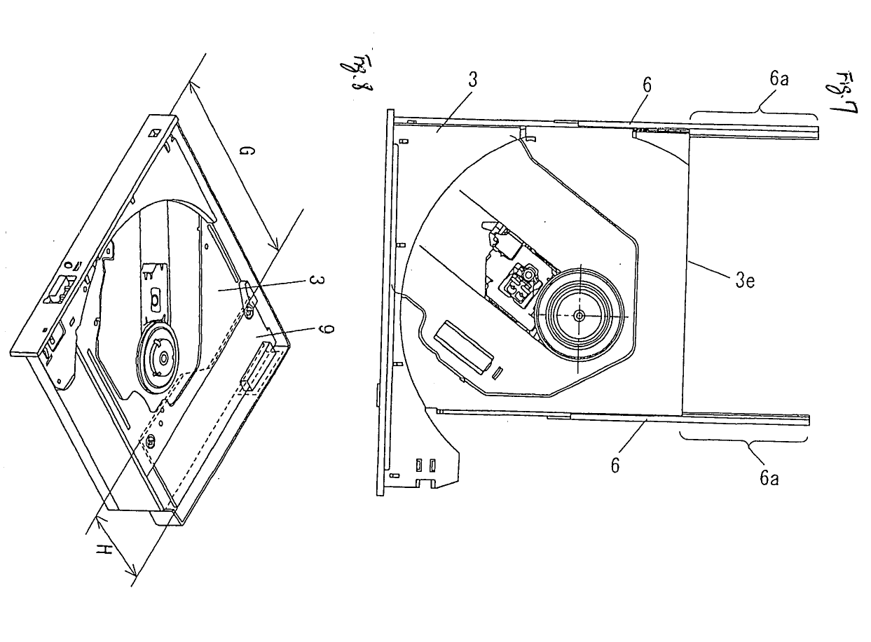

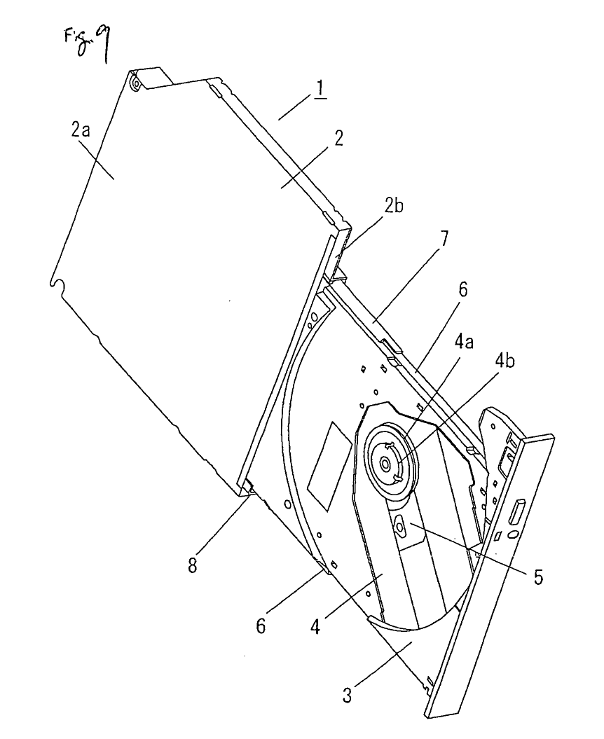

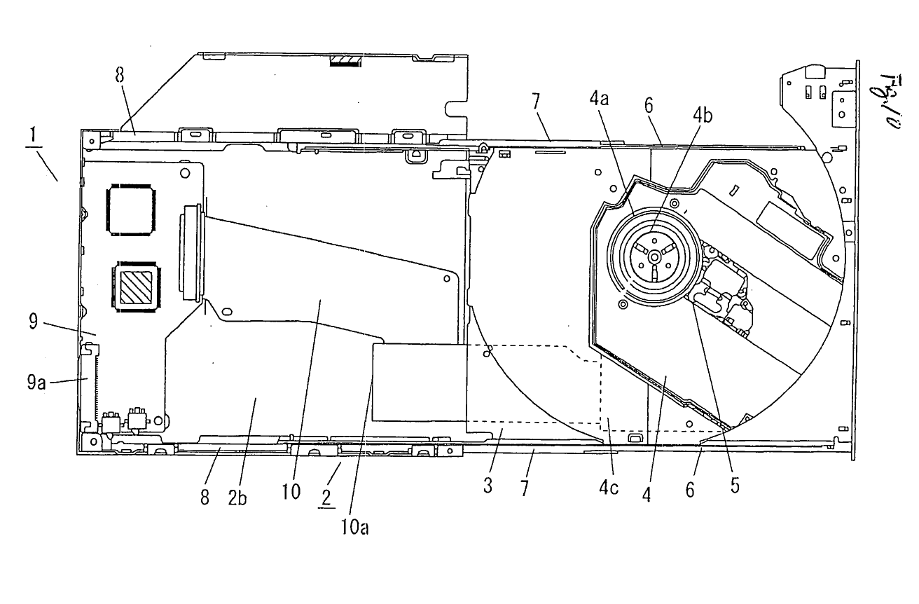

FIG. 1 is an outlook view of a state of drawing out a tray at an optical disk apparatus according to an embodiment of the invention, FIG. 2 is an outlook view of the state of drawing out the tray by the optical disk apparatus according to the embodiment of the invention in which a ceiling plate of a cabinet is removed, FIG. 3 illustrates side views for explaining operation of attaching an optical disk of the optical disk apparatus according to the embodiment of the invention and views of a state of maximally drawing out a tray, FIG. 4 is an outlook view of a state of drawing out a tray at an optical disk apparatus according to other embodiment of the invention, FIG. 5 is an outlook view showing a state of drawing out the tray by the optical disk apparatus according to other embodiment of the invention in which a ceiling plate of a cabinet is removed, FIG. 6 is a side view for explaining operation of attaching an optical disk at the optical disk apparatus according to other embodiment of the invention, FIG. 7 is a front view of a tray portion of the optical disk apparatus according to other embodiment of the invention, and FIG. 8 is an outlook view showing a state of containing a tray of the optical disk apparatus according to other embodiment of the invention in which a ceiling plate of a cabinet is removed.

In FIG. 1 and FIG. 2, an optical disk apparatus 1 is provided with a cabinet 2 and a tray 3. FIG. 1 and FIG. 2 show a state of maximally drawing out the tray 3 from the cabinet 2. The cabinet 2 is constituted by a ceiling portion 2a and a bottom portion 2b. The tray 3 is provided with a pickup module 4. The pickup module 4 is constituted with a spindle motor 4a for rotating an optical pickup 5 constituting an optical system and a disk and a tray side circuit board 4c constituting a control circuit. The spindle motor 4a is provided with a disk mounting portion 4b to mount the disk to drive to rotate.

Both side portions of the tray 3 are provided with rail portions 6, the rail portions 6 of the both side portions are fitted with rail guides 8 provided at inner faces of both side portions of the cabinet 2 slidably in a direction of drawing out the disk, and the tray 3 can be drawn out from the cabinet 2 to be able to attach and detach the disk. A bezel 11 is mounted to a side portion of the tray 3 on a side of drawing out the tray 3. The bezel 11 is constituted to close an opening portion 2c of the cabinet 2. Further, the tray 3 is provided with a chip off portion 3a at which a portion of the disk is extruded in mounting the disk at one side portion thereof on the side of the rail portion 6.

A connector 9a is provided at a rear side portion 2d of the cabinet 2 constituting a side opposed to the opening portion 2c, and data is transmitted to other electronic apparatus of a computer or the like by being connected thereto via the connector 9a. Further, the connector 9a is provided on a cabinet side circuit board 9 constituting the control circuit. The cabinet side circuit board 9 is connected to the bottom portion 2b of the cabinet 2 by being screwed thereto or locked thereby. The cabinet side circuit board 9 and the tray side circuit board 4c are connected by a flexible print cable 10. The flexible print cable 10 is constituted by substantially a V-like shape or substantially a U-like shape and a portion (hatched portion A in the drawing) thereof is adhered to the bottom portion 2b of the cabinet 2. An end portion thereof proximate to the adhered portion is connected to the cabinet side circuit board 9 via a connector 9b. A portion of the flexible print cable 10 which is not adhered to the bottom portion 2b is connected to the tray side circuit board 4c by being folded back by a fold back portion 10a. The fold back portion 10a is moved in a direction of drawing out the tray 3 by containing or drawing out the tray 3 to and from the cabinet 2. Although in containing the tray 3, the fold back portion 10a becomes mostly proximate to the cabinet side circuit board 9, in order to avoid the fold back portion 10a and the cabinet side circuit board 9 from being brought into contact with each other, the cabinet side circuit board 9 is provided with an escape portion 9c.

In a state of maximally drawing out the tray 3 from the cabinet 2, a distance from an end portion of the opening portion 2c of the cabinet 2 to a rotational center of the spindle motor 4a (B in FIG. 3(b)) is smaller than a radius of an optical disk having a maximum diameter which can be mounted to the disk mounting portion 4b. That is, an amount of maximally drawing out the tray (C in FIG. 3(b)) is set such that a total of the optical disk in a state of being mounted to the disk mounting portion 4b is not exposed but a portion thereof is put into the cabinet 2. The maximum drawing out amount C is set by restricting an amount of sliding the rail guide 8 relative to the rail portion 6 by locking portions (not illustrated) provided at the rail portion 6 of the rail guide 8. An end portion of the tray 3 on the side of the cabinet is provided with a notched portion 3b constituted by notching a portion thereof and the end portion of the tray 3 on the side of the cabinet is constituted to be recessed to the side of the spindle motor 4a.

As shown by FIG. 3(a), according to the optical disk apparatus of the background art, the amount C of drawing out the tray is larger than the maximum diameter of the optical disk and therefore, the disk is made to be proximate to the disk mounting portion 4b in a direction of a rotating shaft of the spindle motor 4a to mount thereto. As shown by FIG. 3(b), according to the optical disk apparatus of the embodiment of the invention, the amount C of drawing out the tray is smaller than the maximum diameter of the optical disk and by setting C to a pertinent value, the optical disk can be mounted thereto by sliding the optical disk in a direction of an arrow mark J and positioning a hole at a center of the optical disk to the disk mounting portion 4b and pressing the optical disk in a direction of an arrow mark K. In this case, a shape of the notched portion 3b is set such that a front end portion 12 in a direction of sliding the optical disk is avoided from being collided with the tray 3. An amount of drawing out the tray and an amount of notching the notched portion 3b are set in consideration of performance of attaching and detaching the disk. For example, it has been confirmed that the optical disk can be mounted thereto without a hindrance by the above-described mounting method in the case in which a distance D from an end portion 3d of a side face 3c of the notched portion 3b to the ceiling plate 2a of the cabinet 2 is 4 mm, when a distance E from the side face 3c of the notched portion 3b to a rotational center of the spindle motor 4a is 45 mm and the distance B from the end portion of the cabinet 2 on the side of the opening portion 2c to the rotational center of the spindle motor 4a in maximally drawing out the tray is equal to or larger than 30 mm.

Further, although depending on the distance D from the end portion 3d of the side face 3c of the notched portion 3b to the ceiling plate 2a of the cabinet 2 or the amount of maximally drawing out the tray 3, there is a case of being able to attach and detach the disk without a hindrance even when the notched portion 3b is not provided, in such a case, the notched portion 3b can also be omitted.

By constructing the above-described constitution, the tray 3 does not come out from the cabinet 2 and therefore, the rail portion 6 and the rail guide 8 are maintained to be fitted with each other even in the state of maximally drawing out the tray 3. That is, the rail portion 6 and the rail guide 8 are slidably be fitted with each other in the direction of drawing out the disk without needing the rail present in the background art, the structure can be simplified, the number of parts can be reduced and the weight of the optical disk apparatus can be reduced. Further, by providing the notched portion 3b constituted by notching a portion of the end portion of the tray 3 on the side of the cabinet and constituting the end portion of the tray 3 on the side of the cabinet to be recessed to the side of the spindle motor 4a, attachment and detachment of the disk is further facilitated and operability is promoted. Further, the amount of drawing out the tray 3 is smaller than that of the background art and therefore, a length of the flexible print cable 10 can be shortened and the cabinet side circuit board 9 and the tray side circuit board 4c can be connected further inexpensively.

Further, although according to the embodiment, the end portion of the tray 3 on the cabinet side in the direction of drawing out the tray 3 is constituted to provide the notched portion 3b recessed to the side of the spindle motor 4a, the tray 3 may be constituted to be recessed in a direction of a rotating shaft of the spindle motor 4a on a side of the cabinet of the spindle motor 4a in the drawing direction. Further, the tray 3 may be constituted to be lowered in the direction of the rotating shaft of the spindle motor 4a, in other words, to be remote from the mounted optical disk as proceeding to the side of the cabinet in the drawing direction from the spindle motor 4a.

That is, in consideration of a distance between a disk mounting face opposed to a data reading face of the optical disk when the optical disk is mounted to the disk mounting portion 4b of the spindle motor 4a and the mounted optical disk, the tray 3 having such a constitution includes a portion of increasing the distance between the optical disk and the disk mounting face on the side of the cabinet of the spindle motor 4a in the drawing direction and when the optical disk is mounted to the tray 3 drawn out from the cabinet 2 or when the optical disk is removed from the tray 3, the front end portion 12 of the optical disk can be avoided from being collided with the tray 3.

A detailed explanation will be given of an optical disk apparatus according to other embodiment of the invention in reference to FIG. 4, FIG. 5 and FIG. 6 as follows.

According to the embodiment, the tray 3 is constituted such that a portion of the disk is extruded from the tray 3 from the side of the cabinet 2 in mounting the disk. That is, the distance E from the rotational center of the spindle motor 4a to a side face 3e of the tray 3 on the side of the cabinet 2 is smaller than the maximum diameter of the disk to be mounted. The distance E is set in consideration of performance of attaching and detaching the disk. As shown by FIG. 6, in such a constitution, although the amount of C of drawing out the tray is smaller than the maximum diameter of the optical disk, by pertinently setting the amount C of drawing out the tray, the optical disk can be mounted by positioning the hole at the center of the optical disk to the disk mounting portion 4b by slipping the optical disk in the direction of the arrow mark J and pressing the optical disk in the direction of the arrow mark K. For example, in the case in which the distance D between an end portion 3f of the side face 3e of the tray on the side of the cabinet 2 to the ceiling plate 2a of the cabinet 2 is 4 mm, when the distance E from the side face 3e of the tray 3 on the side of the cabinet 2 to the rotational center of the spindle motor 4a is 35 mm and the distance B from a side end portion of the cabinet 2 on the side of the opening portion 2c to the rotational center of the spindle motor 4a when the tray is maximally drawn out is 30 mm, the optical disk can be mounted without a hindrance by the above-described mounting method.

Further, an end portion at which the side face 3e of the tray 3 on the side of the cabinet 2 and a surface of the tray 3 are intersected may be faced to form an inclined portion 3g. Thereby, the performance of attaching and detaching the disk is further promoted. Similarly, even when the end portion 3d of the side face 3c of the notched portion 3b according to the embodiment explained in reference to FIG. 3 is faced to provide an inclined portion, a similar effect can be achieved.

According to the embodiment, by constituting in this way, a dimension of the tray 3 in the direction of drawing out the tray 3 is reduced and therefore, a volume of the tray 3 is reduced and the tray 3 can be light-weighted. Further, attachment and detachment of the disk is further facilitated to promote operability.

Further, according to the embodiment, in a state of maximally drawing out the tray 3, a portion of the tray 3 remaining at inside of the cabinet is not present or small and therefore, the rail 7 is provided similar to the background art. That is, the both side portions of the tray 3 are provided with the rail portions 6 and the both side portions are slidably fitted with the rails 7 in the direction of drawing out the disk. Further, the rails 7 are also fitted with the rail guides 8 provided at the inner faces of the both side portions of the cabinet 2 sidably in the direction of drawing out the disk and the tray 3 can be drawn out from the cabinet 2 to be able to attach and detach the disk.

However, for example, when the rail portion 6 is projected to the side of the cabinet 2 from the side face 3e of the tray 3 on the side of the cabinet 2 to extend, in all the moving range of the tray 3, slidable fitting of the rail portion 6 and the rail guide 8 can be maintained and therefore, the rail 7 can be removed and the tray 3 can further be light-weighted. In this case, although a projected portion 6a of the rail portion 6 is set with a shape to ensure strength, as shown by FIG. 7, the rail portion 6 and the tray 3 may be separated from each other, and the rail portion 6 may be constituted by a material capable of ensuring necessary strength. In this case, in fixing the rail portion 6 to the tray 3, the rail portion 6 can be fixed thereto by an adhering agent, fixed thereto by screwing, fixed thereto by welding after providing a welding portion, fixed thereto by locking after providing a locking portion, or fixed thereto by compounding these. When the constitution is used, the rail portion 6 can be strengthened and the optical disk apparatus can be light-weighted by reducing the volume of the tray 3.

Further, by setting a depth G of the tray 3 shown in FIG. 8 or a length of the cabinet side circuit board 9 in the direction of drawing out the tray to a pertinent length, in a state of containing the tray 3 in the cabinet 2, the tray 3 and the cabinet side circuit board 9 can be constituted not to overlap each other in the direction of the rotating shaft of the spindle motor (not illustrated). According to the optical disk apparatus of the prior art, portions of the tray and the cabinet side circuit board overlapped in the direction of rotating shaft of the spindle motor are produced and therefore, according to an optical disk apparatus of a thin type, there is a case in which a printed board of a thin type which is more expensive than a general printed board needs to be used. However, according to the constitution, the tray 3 and the cabinet side circuit board 9 are not overlapped in the direction of the rotating shaft of the spindle motor and therefore, an inexpensive printed board having a general thickness can be used for the cabinet side circuit board 9.

Further, in the embodiment shown in FIG. 5, the amount of drawing out the tray 3 can also be set such that the total of the mounted optical disk is drawn out from the cabinet 2 to expose in the state of maximally drawing out the tray 3 from the cabinet 2 similar to the background art. Also in this case, the effect of light-weighted formation by reducing the volume of the tray 3 can be achieved. In addition thereto, by pertinently setting the depth G of the tray 3 and the length H of the cabinet side circuit board 9 in the direction of drawing out the tray, in the state of containing the tray 3 in the cabinet 2, the tray 3 and the cabinet side circuit board 9 can be constituted not to overlap in the direction of the rotating shaft of the spindle motor, the thickness of the circuit board can be avoided from being influenced by the thickness of the optical disk apparatus and therefore, an inexpensive circuit board having a general thickness can be used in the optical disk apparatus of the thin type.

The optical disk apparatus of the invention is applicable to an optical disk apparatus used by being included or outwardly connected to an electronic apparatus can particularly be applicable to a thin type and light-weighted optical disk apparatus.

This application is based upon and claims the benefit of priority of Japanese Patent Application No2003-344147 filed on Mar. 10, 2002, Japanese Patent Application No2004-266400filed on Apr. 09, 1914, the contents of which are incorporated herein by references in its entirety.

1. An optical disk apparatus comprising:
a cabinet, having an opening portion;
a tray, insertably and drawably held to and from the cabinet and brought in and out to and from the opening portion; and
a motor, provided at the tray and holding an optical disk and driven to rotate;
wherein a distance from an end of the opening portion to a rotational center of the motor in a state of maximally drawing out the tray is smaller than a radius of the optical disk having a maximum diameter capable of being mounted to the motor.

2. The optical disk apparatus according to claim 1, wherein:
the cabinet includes a rail guide portion,
the tray includes a rail portion, and
the tray is held by the cabinet insertably and drawably by sliding the rail guide portion and the rail portion.

3. The optical disk apparatus according to claim 2, wherein the rail portion is constituted separately from the tray and is fixed to the tray.

4. The optical disk apparatus according to claim 1, wherein the tray includes a recessed portion on a side of the cabinet in a direction of being drawn out.

5. The optical disk apparatus according to claim 1, wherein the tray includes a recessed portion recessed in a direction of a rotating shaft of the motor on a side of the cabinet in a direction of being drawn out.

6. The optical disk apparatus according to claim 1, wherein the tray includes a portion increasing a distance between the tray and the optical disk held by the motor having the maximum diameter capable of being mounted on a side of the cabinet in a direction of being drawn out.

7. The optical disk apparatus according to claim 1, wherein a distance between the tray and the optical disk held by the motor and having the maximum diameter capable of being mounted is increased as proceeding to a side of the cabinet in a direction of being drawn out.

8. The optical disk apparatus according to claim 1, wherein the tray includes a recessed portion recessed to the motor on a side of the cabinet in a direction of being drawn out.

9. The optical disk apparatus according to claim 8, wherein a portion of the optical disk held by the motor and having the maximum diameter capable of being mounted extrudes from the recessed portion.

10. The optical disk apparatus according to claim 1, wherein the tray includes a notched portion on a side of the cabinet in a direction of being drawn out.

11. The optical disk apparatus according to claim 10, wherein a portion of the optical disk held by the motor and having the maximum diameter capable of being mounted extrudes from the notched portion.

12. The optical disk apparatus according to claim 1, wherein a portion of the optical disk held by the motor and having the maximum diameter capable of being mounted extrudes from an end portion of the tray on a side of the cabinet in a direction of being drawn out.

13. The optical disk apparatus according to claim 12, wherein a circuit board provided at inside of the cabinet and the tray do not overlap each other in a direction of a rotating shaft of the motor in a state of containing the tray in the cabinet.
